(19) United States
(12) Patent Application Publication
(10) Pub. No.: US 2014/0123745 A1
(43) Pub. Date: May 8, 2014

(54) DEVICES AND METHODS FOR EVALUATING HAIR FIXATIVE COMPOSITIONS

(71) Applicants: George D. Green, Cary, IL (US); Raymond J. Swedo, Mount Prospect, IL (US)

(72) Inventors: George D. Green, Cary, IL (US); Raymond J. Swedo, Mount Prospect, IL (US)

(73) Assignee: Angus Chemical Company, Buffalo Grove, IL (US)

(21) Appl. No.: 14/126,167

(22) PCT Filed: Jun. 12, 2012
(86) PCT No.: PCT/US12/42010

§ 371 Date: Dec. 13, 2013

Related U.S. Application Data
(60) Provisional application No. 61/496,360, filed on Jun. 13, 2011.

(51) Int. Cl. G01N 19/00; B29C 53/32

(52) U.S. Cl. CPC G01N 19/00; B29C 53/32
USPC 73/150 R; 425/391

(57) ABSTRACT

The present invention involves using mechanized strategies to fabricate test samples as well as strategies for selecting sample substrates. These strategies significantly reduce the effort and the variabilities associated with making test samples and testing hair fixative compositions. The technology allows simple, rapid, inexpensive evaluation of hair fixative compositions in a way that generates consistent, reliable data. The quality of the data is high enough to facilitate easier qualitative and quantitative comparisons among compositions under investigation. In preferred modes of practice, the present invention provides a simple way to screen new polymer systems and other developmental products. Additionally, this invention can be used to generate more meaningful comparative data for customer and personal care industry presentations.

### PRIORITY

The present patent application claims priority from U.S. Provisional patent application having Ser. No. 61/496,360, filed on Jun. 13, 2011, by Green et al. and entitled DEVICES AND METHODS FOR EVALUATING HAIR FIXATIVE COMPOSITIONS, wherein the entirety of said provisional patent application is incorporated herein by reference.

### FIELD OF THE INVENTION

The present invention relates to devices and methods useful for evaluating the characteristics of hair fixative compositions.

### BACKGROUND OF THE INVENTION

High humidity curl retention is a measure of the viscoelastic relaxation of a resin-hair matrix composite as a function of humidity. High humidity curl retention (HHCR) testing is a standard performance metric used to determine the ability of a given hair fixative to resist sagging under hot and humid conditions. See A. L. Micchelli, F. T. Koehler; J. Soc. Cosmetic Chemists, 19, 863, 1968.

In a typical procedure, tresses of human hair are soaked with a fixative composition and then are wound by hand around foam hair curlers or other mold to provide samples for testing. After drying, the curled tresses are hung vertically in an environment in which temperature and humidity are controlled. The extent of curl relaxation as a function of time is measured. Typically, the hanging coils lengthen as the testing progresses due to sagging.

The industry standard of hand wetting a hair tress with fixative, hand winding around a soft foam curler, drying and manual removal of the tress from the coil is highly labor intensive and introduces a large number of variables in the curled tress preparation. Further, human hair varies considerably by ethnicity, age, color, and other factors that create variations in the testing as well. Consequently, gathered data lacks consistency, accuracy, and reliability. This complicates making comparisons among hair fixative compositions to assess which ones perform better in HHCR testing. The data problem is even worse when data is obtained over an extended period of time.

The properties of test tresses can vary so much that it can be difficult to consistently identify qualitative trends among hair fixative candidates, particularly if the samples are prepared and evaluated at different points in time. Meaningful quantitative comparisons are even more difficult. Better testing strategies are needed for assessing HHCR characteristics of hair fixative compositions.

### SUMMARY OF THE INVENTION

The present invention involves using mechanized strategies to fabricate test samples as well as strategies for selecting sample substrates. These strategies significantly reduce the effort and the variabilities associated with making test samples and testing hair fixative compositions. The technology allows simple, rapid, inexpensive evaluation of hair fixative compositions in a way that generates consistent, reliable data. The quality of the data is high enough to facilitate easier qualitative and quantitative comparisons among compositions under investigation. In preferred modes of practice, the present invention provides a simple way to screen new polymer systems and other developmental products. Additionally, this invention can be used to generate more meaningful comparative data for customer and personal care industry presentations.

In one aspect, the present invention relates to a method of evaluating a material that is useful as at least a portion of a hair fixative composition, comprising the steps of
providing a composite coil comprising a coil substrate and a fixative coating provided on at least a portion of the coil substrate, wherein:
   the substrate coil comprises a plurality of turns and at least a portion of the turns are spaced apart; and
   the fixative coating is derived from one or more ingredients including at least the material; and
evaluating a sag resistance characteristic of the composite coil.

In another aspect, the present invention relates to a method of evaluating a material that is useful as at least a portion of a hair fixative composition, comprising the steps of:
providing a supply of a substrate;
using a mechanized force to cause transport of the substrate;
causing the mechanistically transported substrate to be wetted by a fluid precursor of a curable fixative composition;
guiding the wetted, mechanistically transported substrate onto a rotating mandrel in a manner such that the substrate forms a coil comprising spaced apart turns on the mandrel;
curing the wetted fluid precursor in a manner such that a composite coil comprising a cured fixative composition coated onto at least a portion of the coiled substrate is formed; and
causing a sag resistance characteristic of the composite coil to be evaluated.

In another aspect, the present invention relates to a method of evaluating a material that is useful as at least a portion of a hair fixative composition, comprising the steps of:
providing a composite coil comprising a coil substrate and a cured, fixative coating provided on at least a portion of the coil substrate, wherein:
   the substrate coil comprises a non-human fiber; and
   the fixative coating is derived from one or more ingredients including at least the material; and
causing a sag resistance characteristic of the composite coil to be evaluated.

In another aspect, the present invention relates to an apparatus for making a composite coil precursor, comprising:
a supply comprising a fiber that is a surrogate for a human hair fiber;
a wetting station at which the fiber is wetted with a fluid precursor constituting at least a portion of a cured fixative composition;
a mechanically driven, rotatably supported mandrel on which the wetted fiber is drawn from the supply and wound on the mandrel during rotation of the mandrel in a manner effective to form a composite coil precursor comprising a plurality of spaced apart turns;
a mechanically driven, translatable guide that helps to guide the transported fiber onto the mandrel during translation of the guide, wherein the translation of the guide is coordinated with the rotation of the mandrel during at least a portion of the time that the wetted fiber is wound on the rotating mandrel, said coordination occurring in a manner effective to help provide a desired spacing pattern among the spaced apart turns of the coil.

In another aspect, the present invention relates to an apparatus for making a composite coil precursor; comprising:
a tensioned, wetted fiber, wherein the fiber comprises a human hair surrogate and wherein the fiber is wetted with a fluid precursor constituting at least a portion of a cured fixative composition; and
a rotatably supported, mechanically driven mandrel on which the tensioned, wetted fiber is wound to provide a composite coil precursor, said composite coil precursor comprising a plurality of spaced apart turns, and wherein the mandrel is operatively coupled to a driving force in a manner effective to cause mechanically driven rotation of the mandrel on demand.

### BRIEF DESCRIPTION OF THE DRAWINGS

FIG. 1 is a top schematic view of an illustrative embodiment of a mechanized apparatus of the present invention useful for making composite coils, wherein a portion of a composite coil is formed on the rotating mandrel.

FIG. 2 is a side view of the apparatus of FIG. 1.

FIG. 3 shows how a long coil made on the apparatus of FIG. 1 can be cut into smaller coils more suitable for HHCR testing.

FIG. 4 shows the apparatus of FIG. 1 in a subsequent state in which an additional portion of the composite coil is formed on the rotating mandrel.

FIG. 5 shows an optional accessory used with the apparatus of FIG. 1, wherein the accessory is an additional translatable guide system.

FIG. 6 shows composite coils hung on a rack at the beginning of an HHCR test.

FIG. 7 shows the composite coils of FIG. 6 after the coils have been aged pursuant to the HHCR test.

### DETAILED DESCRIPTION OF ILLUSTRATIVE EMBODIMENTS

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention. All patents, pending patent applications, published patent applications, and technical articles cited herein are incorporated herein by reference in their respective entireties for all purposes.

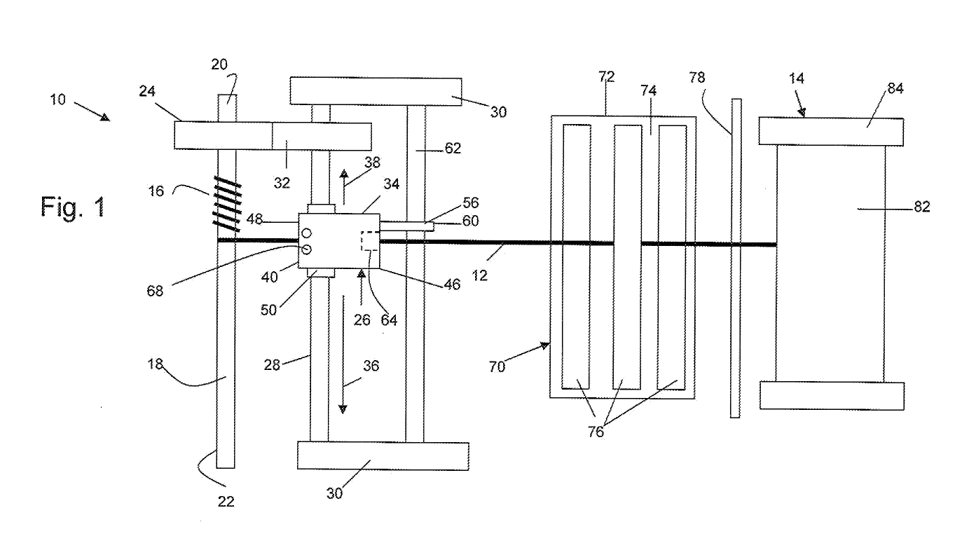

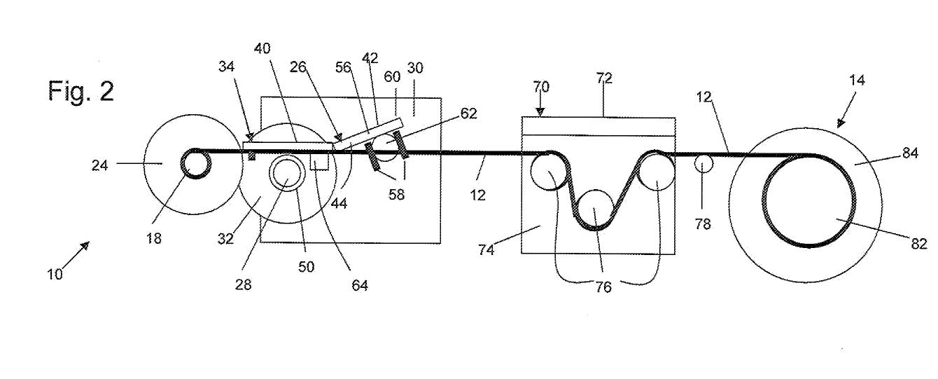

An illustrative embodiment of a mechanized coil winding system 10 of the present invention is schematically shown in FIGS. 1 and 2. System 10 reproducibly prepares composite coils 16 by coating hair fixative compositions onto a wide range of fiber substrates that are surrogates for human hair. System 10 prepares the composite coils 16 rapidly and inexpensively. The composite coils 16 are useful in tests that measure the high humidity curl retention of hair fixative compositions.

System 10 uses fiber 12 from fiber supply 14 as a substrate to form composite coil 16 on mechanically driven, rotatable mandrel 18. As used herein, the term fiber refers to a flexible material having a length that is much greater than the largest cross-sectional diameter of the material. In preferred embodiments, this length to diameter ratio for a sample portion of the fiber having a length of 10 cm is at least about 10:1, preferably at least about 100:1, more preferably at least about 1000:1, or even at least about 10,000:1. In illustrative embodiments by way of example, exemplary fiber strands have a diameter in the range from about 0.5 micrometers to about 10 mm. One or more of such strands may be incorporated into a resultant fiber, often from 1 to about 12 strands. Most preferably, fibers are single stranded.

A fiber is considered to be flexible for purposes of the present invention if the fiber can be wound without fracture at 25° C. around a mandrel having a diameter of ⅝ inches (15.9 mm). Preferably, fiber 12 is low stretch. Low stretch with respect to a fiber means that the fiber elongation percentage, E, is less than 20%, preferably less than 15%, more preferably less than 3% when a 50 g weight is hung from a 6 inch (15.2 cm) length of the fiber at 25° C. at a relative humidity of 10% for a period of 15 minutes. Fiber elongation percentage, E, is given by the expression

E=([L_{w}−6]/6)×100%

Where L_{w} is the length in inches of the fiber after the test, wherein the fiber has an initial length of 6 inches. In one embodiment, a wool fiber stretches from 6 inches (15.2 cm) to 6.75 inches (17.1 cm) according to this test, indicative of a fiber elongation percentage of 12.5%. The fiber is a 100% wool, BFL yarn made of 3 twisted plies of multi-filament strands having a typical weight of 100 g per 181 yards.

Fiber substrates may have a variety of cross-sections. By way of example, the cross-sections of exemplary fiber substrates may be round, oval, ribbon-like, rectangular, triangular, or the like. Fiber substrates of the present invention desirably have a substantially uniform cross-section along the fiber length. This helps ensure that coils made from different portions of the fiber have uniform properties. This enhances the ability to collect reliable, consistent data. Desirably, the fiber 18 has sufficient integrity in terms of physical strength and mechanical properties to be drawn from supply 14 and wound on mandrel 18 in the course of being coated in system 10 without undue risk of snapping, fraying, or otherwise suffering from undue physical degradation or damage.

According to many conventional evaluation strategies, fixative compositions are coated onto human hair substrates by manually winding hair tresses on a mandrel. However, hair characteristics very considerably with factors such as ethnicity, age, health, season, color, and the like. These substrate variations undermine the ability to obtain consistent, reproducible data. Coil characteristics also can vary based upon the winding techniques used to make coils. For instances, variations in winding tension can cause coil characteristics to vary even when substrate properties are more uniform. Consequently, the data obtained from coils whose substrates are solely human hair suffer from too much variation.

Advantageously, use of the mechanized system 10 to prepare composite coils from fiber substrates that are surrogates for human hair minimizes the labor and variations associated with test data when coils are wound manually and/or human hair is used as the substrate. These alternative fibers have more uniform characteristics. This allows gathered data to be more consistent when gathered contemporaneously or even over long periods of time. The substrates of the present invention also provide test data with a higher degree of granularity, making sample comparisons easier, more accurate, and more meaningful.

A wide range of materials may be used as fiber substrates as alternative(s) to human hair. These include natural and/or synthetic non-human animal hair, polymers, cellulosic materials, combinations of these, and the like. In preferred embodiments, a fiber substrate comprises wool fiber. Wool has been found to be a fiber substrate that provides reliable, consistent data with a high degree of granularity. Further, performance of hair fixative compositions on wool has an excellent correspondence to performance on human hair, which helps to make gathered data very meaningful and useful for developing commercial hair fixative products.

An exemplary wool fiber substrate is a Blue Faced Leicester (BFL) yarn that includes 3 twisted plies of multi-filament strands. Such a fiber has a typical weight of 100 g per 181 yards. Another useful fiber embodiment is a yarn that includes three strands of multi-filament fiber made up of a blend of merino, cashmere and nylon fibers. This is also available in weight/length ratios similar to the 100% BFL wool yarn. In general with respect to multi-filament embodiments, nearly any multi-filament fibrous substrate providing substantial opportunity for filament to filament bonding when treated with a fixative resin could be useful. It is desirable, however, to further consider surface property effects in the selection of a substrate as the properties of the resulting composite structure depend heavily on adhesion between the substrate and matrix resin.

Wool yarn embodiments may be obtained with a favorable, unidirectional composite structure. Wool is available in large, single lots and in a continuous form that greatly facilitates a mechanized coil preparation scheme. While wool yarn and flat hair tress are different in their physical form, wool yarn is a multistrand construct formed from hundreds of individual fiber strands. that provide an ideal substrate for fixing individual strands to one another in a composite structure. In contrast to practices in which human hair is coiled into a tress for HHCR evaluation, yarn can be wound into a “coil spring” according to principles of the present invention. In some embodiments, multiple yarn fibers can be used to make multi-layer coils.

In an exemplary embodiment, the substrate fiber comprises wool, and the hair fixative composition includes an amine-neutralized (meth)acrylic polymer. Experiments confirm that wool is an excellent surrogate for human hair tresses. In HHCR studies, we have found that the results obtained using wool-based coils to evaluate HHCR characteristics of amine-neutralized (meth)acrylic polymers correlated very well with data obtained using human hair-based tresses. Indeed, using wool-based composite coils presents the ability to discriminate among various neutralizing amines with a higher degree of granularity as compared to using human-hair based tresses.

So long as non-human hair fibers are used, the substrates may also include some human hair as a constituent. For example in some embodiments, substrates may include a combination in which the weight ratio of human hair fiber to one or more non-human hair fiber(s) is in the range from 100:1 to 1:100, preferably 20:1 to 1:20, or even 3:1 to 1:3. In particularly preferred embodiments, the fiber constituents of the substrates are substantially all sourced from one or more kinds of non-human hair fibers such that the substrates substantially exclude human hair content.

Mandrel 18 may have a wide range of geometries. In illustrative embodiments, the mandrel is an elongated member having a generally cylindrical geometry with a circular or otherwise rounded cross-section such as a circular or oval cross-section, a spiral geometry, a rectilinear geometry, conical (decreasing radius), combinations of these, and the like. The cross-section may be generally uniform along the length of mandrel 18 or may vary to control the shape and structure of the resultant coil. In one mode of practice, the mandrel is a cylindrical member having a diameter of 0.625 inches (15.9 mm) and a length of about 18 inches (46 cm).

The rotation of mandrel 18 is power driven via power input end 20 that is rotatably coupled to a suitable mechanized rotatable driving force such as an electric motor (not shown) optionally with a gear box (not shown) or the like. Using mechanized winding strategies to form the composite coil 16 provides many advantages. Mechanized winding is simple, rapid, and inexpensive. Composite coils 16 are made with a high degree of reproducibility (e.g., forming coils via fibers having uniform tension, forming coils with uniform coil spacing, etc.) so that resultant composite coils 16 have uniform properties. Mechanization significantly reduces variation in substrate properties, allowing different hair compositions to be evaluated much more consistently and accurately with a higher level of resolution. In particular, the mechanized devices and procedures of the present invention may be used to rapidly and reproducibly perform high humidity curl retention HHCR tests on hair fixative formulations without requiring the use of human hair as a substrate for the compositions under evaluation.

Mandrel 18 has free end 22 to allow composite coils to be easily removed from mandrel 18. Mandrel 18 also may be removable so that a composite coil formed on mandrel 18 can easily be transferred to another work station, e.g., a drying oven, for further processing, packaging, and/or the like. Drive gear 24 is mounted on mandrel 18 and can be used to transfer rotational driving power to one or more other components of system 10. As shown, drive gear operatively meshes with reel gear 32 of translatable guide system 26. Translatable guide system 26 also includes rotatable threaded rod 28 that is rotatably supported upon mounts 30 at each end. Gear 32 is fixedly mounted onto threaded rod 28. Rotation of drive gear 24 causes corresponding rotation of gear 32, which spins the threaded rod 28.

Desirably, mandrel 18 is treated with a suitable mold release agent to facilitate removal of composite coils. A wide variety of release agents may be used. More desired mold release agents are dry at the time of use (even if wet at the time of application) and have compositions that minimize risk of contaminating the composite coil. In one embodiment, a mold release agent comprising at least one fluoropolymer such as polytetrafluoroethylene or the like, would be suitable. An exemplary mold release agent comprising a fluoropolymer is supplied as a spray and is commercially available under the trade designation Miller-Stephenson MS-122 Fluorocarbon Release Agent Dry Lubricant. This release agent allows coils to be removed easily from mandrel 18 without breaking or distorting the coils. Advantageously, this agent is non-oily to avoid being absorbed into the coils in a manner that might unduly alter the coil performance properties.

Translatable guide 34 is threadably engaged with threaded rod 28 in a manner such that rotation of rod 28 causes linear motion of the guide 34 along rod 28. Rotation of rod 28 in one direction (e.g., clockwise rotation) causes guide 34 to linearly translate in the direction shown by arrow 36. Rotation of rod 28 in the other direction (e.g., counter-clockwise rotation) causes guides 34 to linearly translate in the direction shown by arrow 38.

Translatable guide includes plate 40 having upper face 42, lower face 44, first end 46, and second end 48. Threaded collar 50 is fixedly attached to plate 40 and is used to threadably couple guide 34 to rod 28. Collar 50 can be integrally formed with plate 40 or can be a separate component that is attached to plate 40 in a variety of ways such as by glue, welds, bolts, screws, clamps, combinations of these, or the like. In one embodiment, plate 40 has slots (not shown) and collar 50 has corresponding threaded bores (not shown) so that plate 40 can be attached to collar 50 using screws (not shown).

Because guide 34 is threadably mounted onto rod 28, guide 34 and rod 28 could rotate in concert or independently of each other. However, without constraining the rotation of guide 34 as rod 28 rotates, guide 34 may tend to rotate with rod 28 at least to some degree. Such rotation could undermine not only the desired linear translation of guide 34 along rod 28, but also the fiber-guiding function performed by guide 34. Accordingly, the rotation of guide 34 desirably is constrained to help ensure that rotation of rod 28 causes linear translation of guide 34. To this end, stabilizer bar 56 extends from plate 40. Pins 58 extend from stabilizer bar end 60 to engage fixed rod 62 to prevent rotation of guide 34 as rod 28 spins. The ends of fixed rod 62 are supported in any suitable fashion. As shown, rod is fixedly supported upon mounts 30.

Fiber guiding features of translatable guide 34 include die 64 is mounted to lower face 44 of guide 34 proximal to first end 46. Die 64 has an orifice (not shown) to help guide fiber 12 that is fed to guide 34. The orifice is also sized to have a relatively close fit around fiber 12 to remove excess hair fixative composition before the fiber 12 is wound onto rotating mandrel 18. For purposes of illustration, only a single die 64 is shown. More can be used if it is desired to simultaneously guide two or more fibers onto mandrel 18 at the same time. Guide pins 68 are positioned proximal to second end 48 and project from lower face 44 to further help guide fiber 12 onto mandrel 18. For purposes of illustration, a pair of pins 68 are shown to guide a single fiber 12 between them. Additional pins 68 can be used to guide additional fibers simultaneously onto mandrel 18. If multiple fibers are guided by pins 68, the gaps between the guiding pins 68 desirably are small enough such that the multiple yarns are forced together forming a single, multistrand fiber structure.

System 10 further includes wetting station 70 at which fiber 12 is coated, wetted, impregnated, or otherwise integrated with a fluid that is a precursor of all or a portion of a hair fixative composition. The precursors may be solutions, dispersions, gels, or the like.

Hair fixative compositions generally refer to compositions that stiffen and immobilize hair, often to preserve a desired hair style. In many instances, these compositions include at least one film forming polymer that forms a stiff coating on hair fibers. Such polymers may be hydrophilic, hydrophobic, or amphoteric. Exemplary polymers used in such compositions include one or more starches, shellac, polyurethanes, polyesters, poly(meth)acrylates, polymers comprising vinylpyrrolidine (VP) repeating units such as polyvinylpyrrolidine (PVP), polymers comprising vinyl acetate repeating units (VA) such as VP/VA copolymers, polymers comprising dimethyl hydantoinformaldehyde (DHF) such as VP/DHF copolymers, combinations of these, and the like.

In addition to film forming polymers, hair fixative compositions often include one or more other ingredients to enhance performance. Other ingredients include one or more fragrances, plasticizers, pH stabilizers, rheology control agents, conditioning agents, nutrients, surfactants, dispersing aids, thickening agents, emollients, preservatives, propellants, inert carriers, antistatic agents, nutriceuticals, medicaments, foaming agents, colorants, combinations of these, and/or the like.

Precursors of the hair fixative compositions generally include providing all or a portion of the composition ingredients in a fluid carrier. The precursors can be solutions, dispersions, gels, or the like. Exemplary fluid carriers include water, alcohols, ethers, esters, ketones, hydrocarbons, combinations of these, and the like. The amount of fluid carrier used in the precursor may vary over a wide range. Exemplary precursor embodiments include from about 500 to about 10,000 parts by weight of fluid carrier per about 100 parts by weight of the hair fixative ingredients admixed with the fluid carrier.

Exemplary hair fixative polymers useful in these compositions are commercially available from a number of sources. These include the products available under the trade designations AMPHOMER (Akzo Nobel), UTRAHOLD STRONG (BASF), LUVISKOL (BASF), chitosan (linear polysaccharide), polyurethane-6, combinations of these, and the like. A large percentage of hair fixative systems use an aminoalcohol commercially available under the trade designation AMP (Angus Chemical Company) as the neutralizer of choice.

Hair fixative compositions are further described in U.S. Pat. Pub. No. 2006/0251600; PCT Pub. No. WO 98/51266; and U.S. Pat. Nos. 4,689,379; 5,275,811; 5,972,329; 6,218,346; and 7,390,478. Hair fixative compositions also are further described in D. Howard and M. Pfaffernoschke, Flexible Hold Hairsprays with Long-Lasting Performance, Intl. J. for Aerosol, Spray, and Packaging Technology (January 2004); A. L. Micchelli and F. T. Koehler, “Polymer Properties Influencing Curl Retention at High Humidity”, J. Soc. Cosmetic Chemists, 19, 863-880 (1968); and D. Krzysik, et al., “A Stiff-Hold Styling Polymer with Humidity Resistance”, HAPPI, May 2007. The entirety of each of these documents from the patent and technical literature is incorporated herein by reference in its respective entirety for all purposes.

Wetting may occur in any desired fashion such as via immersion, spraying, pouring, brushing, curtain coating, pinch rolling, combinations of these, and the like. For purposes of illustration, station 70 uses immersion to accomplish wetting. To this end, station 70 includes a vessel 72 holding a bath 74 comprising the desired wetting fluid. Optional guide rollers 76 can help guide fiber 12 through bath 74. Optional support arm 78 at the infeed side of bath 74 helps to support and tension fiber 12. Station 70 includes a single bath 74 so that wetting occurs in a single stage. In other embodiments, wetting may occur in two or more stages. If multiple wetting stages are practiced, all or a portion of the ingredients may be applied at each wetting stage. The ingredients added at each wetting stage may be the same and/or different.

System 10 further includes fiber supply 14. Supply 14 includes a supply 82 of fiber 12 wound on rotatable supply spool 84. Optionally, spool 84 is provided with a resistance that helps maintain a desired tension in fiber 12 as fiber is pulled through system 10 by the rotation of mandrel 18. The resistance of the spool 84 may be controllable varied to help maintain the desired tension. The tension of fiber 12 can be monitored and suitable tension control applied via feedback and/or feedforward control strategies.

In use, fiber 12 is initially fed through system 10 from supply spool 84 to rotating mandrel via wetting station 70 and then translatable guide system 26. Feeding can occur manually or can be automated if desired. For purposes of illustration, the initial feeding is accomplished manually with respect to system 10. Once properly fed, rotating mandrel 18 can be actuated to begin to pull more fiber 12 through the system to be wound as a coil on mandrel 18.

From spool 84, mechanically driven mandrel 18 draws fiber through wetting station 70 where fiber 70 is immersed and is thoroughly wetted by bath 74. The fluid in bath may coat and/or impregnated the fiber 12 depending upon factors such as the nature of fiber 12, the nature of fluid in the bath, the residence time of fiber 12 in the bath 74, the temperature, bath pressure 74, and/or the like.

After wetting station 70, fiber 12 is led to and through translatable guide system 26. Die 64 helps to lead fiber 12 into system 26 along a desired path while guide pins 68 help to feed fiber 12 onto rotating mandrel 18 at desired feed angle(s) as winding progresses. Guide 34 translates linearly down the length of rod 28 during the course of winding so that the desired feed angle(s) of fiber onto mandrel 18 is/are maintained. Maintaining a constant feed angle, for instance, helps to form coil composites under uniform fiber tension. This in turn leads to composite coils with more consistent characteristics for testing purposes. Data variation is reduced as a result. Guide 34 is mechanically coupled to mandrel 18 to that rotation of mandrel 18 also mechanically drives translation of guide 34.

Due at least in part to the translation of guide 34 during winding, coil composites with spaced apart turns are formed on mandrel 18. The distance between adjacent turns can be controlled by adjusting the translation speed of guide 34 to the rotation speed of mandrel 18. Generally, faster translation of guide 34 relative to mandrel rotation forms composite coils with greater spacing between adjacent turns. Slower translation of guide 34 relative to mandrel rotation forms composites with closer spacing between adjacent turns. Translation of guide 34 also helps to help maintain desired feed angle(s) of fiber 12 onto mandrel 18.

Therefore, the speed at which guide 34 linearly translates along rod 28 during winding is coordinated with the rate at which mandrel 18 rotates to achieve the desired turn spacing and/or the desired feed angle(s). This coordination is achieved by using gears 24 and 32 to rotationally couple mandrel 18 and threaded rod 28. The fiber spacing in the resultant composite coil 16 generally is a direct output from the combination of the rotational speed of the mandrel 18 and the linear velocity of the guide 34 along the threaded shaft 28. The linear velocity of the guide 34 generally is dictated at least in part by the gearing used to couple the rod 28 to mandrel 18 shaft as well as the thread pitch of the threaded collar 50. In exemplary embodiments, apparatus 10 is configured in a manner effective to form composite coils in which the spacing between adjacent coil turns is in the range from about 0.18 inches to about 0.25 inches. In preferred embodiments, the spacing among the coil turns is uniform. In other embodiments, other spacing patterns may be used.

For example, a spacing pattern can accommodate coil stresses. As one approach to accomplish this, consider an HHCR testing situation in which a composite coil is hung from a rack by a first end while the other, second end is allowed to hang free. In this case, the coil turn proximal to the first end is supporting the entire coil mass while the last turn is supporting mainly its own mass. Coil turns between the two end turns support increasingly less mass moving in a direction from the top coil near the first end to the bottom coil near the second end. The mass stresses on the coil turns of a hanging coil, therefore, are not uniform. Accordingly, the spacing between adjacent turns can be increased in a direction from the first end to the second end to accommodate the fact that lower turns support less mass than higher turns.

The resultant composite coil 16 is cured. Depending upon the nature of the composition being evaluated, curing can occur in a variety of ways including physical, or chemical curing. Physical curing can be accomplished by allowing or causing the coil 18 to dry. Drying can occur with heating if desired. For instance, mechanically driven mandrel 18 supporting coil 16 can be removed from system 10 and placed into an oven. Chemical curing can occur via exposure to a suitable source of crosslinking energy (e.g., heat, ultraviolet light, infrared light, e-beam energy, corona discharge, acousting energy, or the like) or can occur via contact with a suitable curing agent and/or catalyst.

To sum up this mode of practice, mandrel 18 functions as a take up rod and pulls fiber 18 from fiber supply 14, through the bath 74, through a fixed orifice associated with die 64 where a squeegee effect is used to remove excess precursor composition, through the guide pins 68, and then onto the mandrel 18. Thus, the apparatus 10 forms composite coil 16 while helping to control composition uptake, spacing of coil turns, and fiber tension.

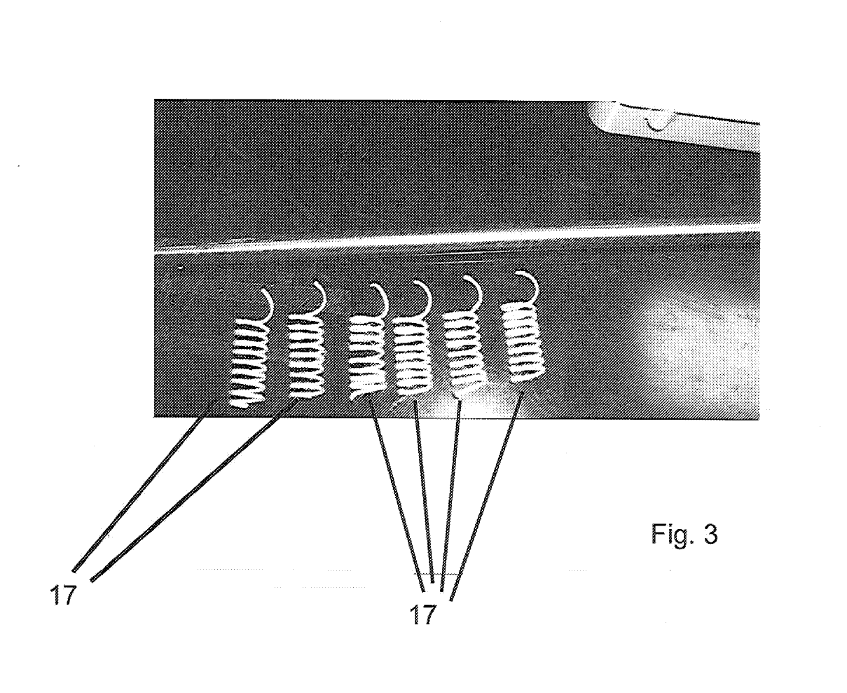

FIG. 3 shows how the relatively long composite coil 16 can be cut into smaller coils 17 that are of a size more suitable for testing. For more consistent results, coils 17 are formed with the same number of turns and generally the same length. The portion of the resultant composite coil formed on mandrel 18 that corresponds to the initial portion of fiber 12 used to feed the fiber 12 through system 10 for start up purposes, or at least the portion downstream from the die 64, can be discarded so that only portions of the composite coil 16 formed with proper tension are later subjected to curl retention studies.

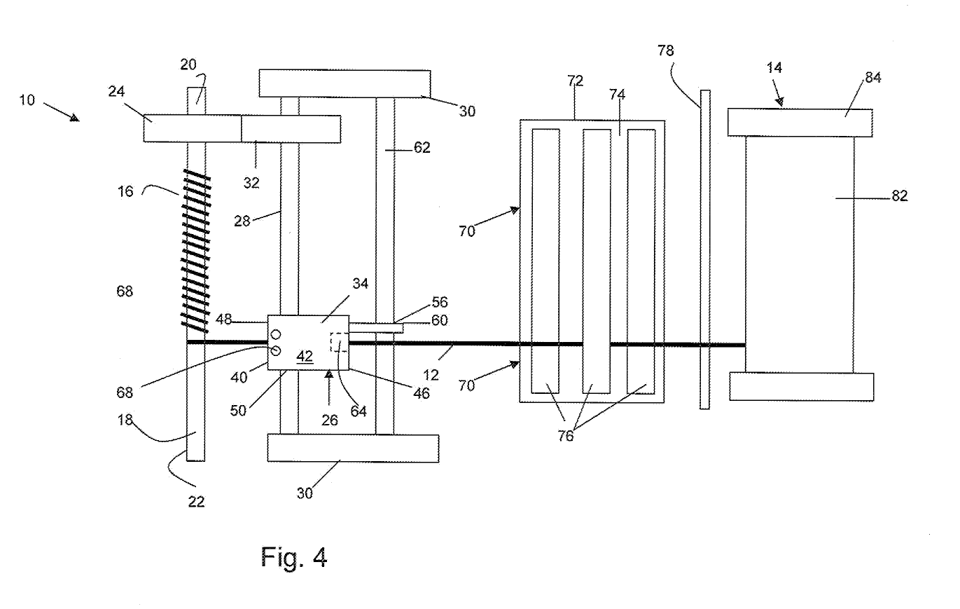

FIG. 1 shows an initial portion of composite coil 16 formed on mandrel 18. FIG. 4 shows a subsequent stage of formation at which a greater portion of composite coil 16 is formed. Note how guide 34 has translated further along rod 28 so that the feed angle of fiber 12 onto mandrel 18 is the same in FIG. 4 as it is in FIG. 1.

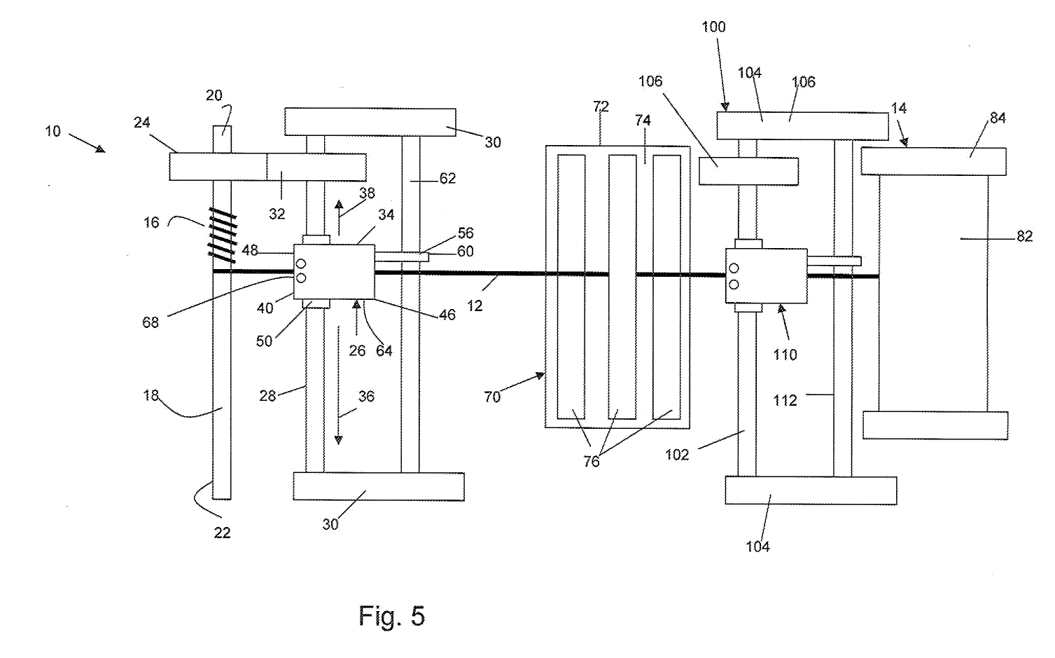

FIG. 5 shows system 10 with an additional, optional accessory 100 to help further enhance uniform, consistent fabrication of composite coils. Accessory 100 is an additional translatable guide system that is generally identical to guide system 26 except that accessory 100 helps to guide fiber 12 into bath 74 at a uniform angle. Thus, accessory 100 also includes threaded rod 102, mounts 104, gear 106, translatable guide 110, fixed rod 112. Additionally, accessory 100 includes belt 114 to operatively couple gear 32 to gear 106. This way, guides 34 and 110 translate along their threaded rods in coordinated fashion. The use of accessory 100 advantageously helps to maintain alignment of the fiber 12 and is also believed to be helpful to establish more uniform fiber tension.

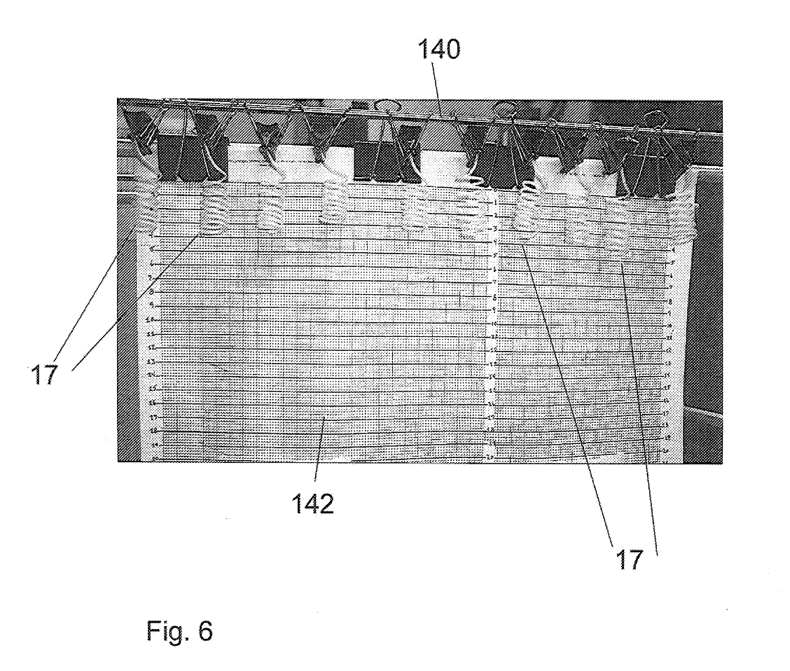

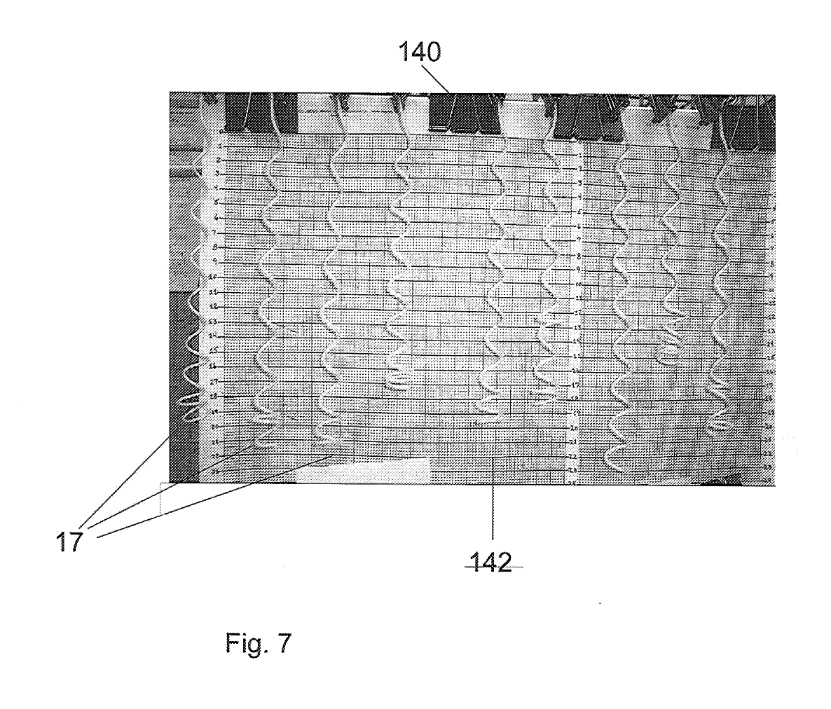

FIGS. 6 and 7 schematically show how curl retention of coil samples 17 can be evaluated under one or more sets of environmental conditions. Referring first to FIG. 6, coil samples 17 are hung from a rack and tested under the desired environmental conditions. The coils are then aged under conditions that show how the samples withstand humidity. For example, one standard industry protocol ages samples at 90% relative humidity at 30° C. for multiple hours. The lengths of the coils before and after testing are compared to assess loss of curl retention, or sag resistance, under the test conditions. Generally, each coil has an initial length, Lo. As the test proceeds, the turns of the coils sag, causing the length of the coil to increase to Ls. The loss of curl retention is expressed as a percentage curl retained according to the following formula:

% Curl Retained=((L_{Overall}−L_{Curl Time T})/(L_{Overall}−L_{Curl Time 0})* 100%

Where
L_{Overall}=length of the fully extended sample
L_{Curl Time T}=Length from the top to the bottom of the curl at time T
L_{curl Time 0}=Length from the top to the bottom of the curl at start of the experiment (initial curl length)

Typically, multiple coils are used and the data averaged to minimize variability.

Generally, a higher level of curl retention corresponds to a fixative composition that is more resistant to sagging. Higher sag resistance generally is more desirable.

To facilitate measuring the coils before the test starts and at one or more times during the progress of a test, the coils 17 are hung from rack 140 in front of a measurement board 142 whose surface has length markings making it easy to measure coil length at any desired time.

FIG. 7 shows schematically how the coils 17 develop sag after testing. In this case, all of the coils have sagged, as is evidenced by their longer lengths after testing, Ls, relative to their initial lengths, Lo, shown in FIG. 6. Coil samples that lengthen more generally have fixative compositions that relaxed more as a consequence of testing. These fixative compositions will have lower sag resistance as evidenced by the initial length of the corresponding coils being a smaller percentage of the resultant length after testing. In other words, a coil sags more when the fixative composition loses more of its fixative strength as a consequence of testing.

In contrast, coils that lengthen less after testing are protected by fixative compositions that retained more of their holding strength. These fixative compositions have much better sag resistance as evidenced by the initial length of the coils being a much higher percentage of the resultant length after testing.

The present invention will now be further described with respect to the following illustrative examples.

### EXAMPLE 1

The apparatus of FIG. 1 is used under ambient conditions to prepare composite coils using wool yarn (3-ply Blue Faced Leicester, BFL, yarn) as the substrate. The wool yarn is pulled from the supply through a resin bath containing an ethanol solution of 12 weight percent solids of AMPHOMER resin neutralized with AMP aminoalcohol (75% degree of neutralization with 50% to 125% degree of neutralization being suitable in many embodiments), through a fixed orifice to squeegee off excess resin solution, and then wound onto a ⅝″ diameter steel rod via a guide mechanism that creates a uniform yarn spacing along the length of the rod. The rod rotates at 20 rpm while the fiber guide translates at 2 mm/s. This yields a coil turn spacing of 6 mm between adjacent coils turns.

Once the wetted coil is formed, the mandrel holding the wetted wool spiral is placed in a 40° C. forced air oven for 10 minutes to facilitate drying. The coils and mandrel are allowed to cool to room temperature. The resultant composite coil is cut into 5 to 6 discrete springs having 9 total turns each. The coils are individually removed by simply sliding them off the end of the bar. One end of each coil is bent to be parallel to the length axis of the coil to facilitate hanging from an HHCR test rack. The test rack is loaded with a plurality of specimens for HHCR testing. At the beginning of an experiment the top spiral of each coil is set to the “0” position relative to the distance grid behind the coils, and the bottom of each coil is allowed to hang freely. The coils are then aged under conditions that challenge the ability of the samples to resist sagging in humid conditions.

### EXAMPLE 2

Composite coils were made according to the procedure of Example 1 using wool yarn as substrates and solutions comprising a variety of aminoalcohols to coat the yarn. Table 1 provides the formulation details of the systems tested. The aminoalcohols used are as follows:
AMP=2-Amino-2-Methyl-1-Propanol (95%) containing 5% water
DMAMP=2-(N,N-Dimethylamino)-2-Methyl-1-Propanol
AEPD=2-Amino-2-Ethyl-1,3-Propanediol 85 wt % in water
AMPD=2-Amino-2-Methyl-1,3-Propanediol
TrisAmino=Tris(hydroxymethyl)-Aminomethane 40 wt % in water
3-AB=3-Amino-2-Butanol
TEA=Triethanolamine

TABLE 1
Formulations for High Humidity Curl Retention
Testing using Wool Coils

| Formu- | | Aminoalcohol | Amphomer | |
|---|---|---|---|---|
| lation # | Aminoalcohol | used (g) | (g) | Ethanol (g) |
| 1 | None | 0 | 12.22 | 87.78 |
| 2 | AMP (95% solids | 2.29 | 12.22 | 85.49 |
| | in water) | | | |
| 3 | DMAMP | 3.05 | 12.22 | 84.73 |
| 4 | AEPD (85% | 3.03 | 12.22 | 84.75 |
| | solids in water) | | | |
| 5 | AMPD | 2.58 | 12.22 | 85.20 |
| 6 | Tris Amino (40% | 7.40 | 12.22 | 80.38 |
| | solids in water) | | | |
| 7 | 3-AB | 2.21 | 12.22 | 85.57 |
| 8 | TEA | 3.68 | 12.22 | 84.10 |

Evaluation of the composite coils according to Table 1 indicated that the coils are more sensitive to humidity than a standard hair tress. This is likely due to the different geometry of the composite structures. Human hair tresses have a significant amount of overlap between layers. Without wishing to be bound, it is believed that this overlap slows the penetration of moisture into the bulk of the coated hair sample. As the coated hair tress slowly uncoils, the under layers, initially protected from environment, get exposed and begin to relax. The coated wool coils of the present invention, however, have spaced apart turns, thus exposing a greater portion of the entire sample to the humid conditions at the onset of the experiment. This results in a much more rapid and dramatic loss of curl.

In one experiment, the coated wool coils of Table 1 were placed directly into a 30° C./90% RH environment and measured every 2 hours for a total of 6 hours. The results of this testing are collected in Table 2.

TABLE 2
Comparison of % Curl retention between Human
Hair and Wool Coils in HCCR Testing

| | | | Wool Coils |
|---|---|---|---|
| | Human Hair | Wool Coils | 30° C./70%, |
| | (30° C./90% | 30° C./ | 80%, 90% RH, |
| Aminoalcohol | RH/6 hrs)¹ | 90% RH/6 hrs)² | 2 hrs each³ |
| None (Blank control) | NA | 95 | 92 |
| TA | 97 | 69 | 71 |
| AMPD | 96 | 51 | 59 |
| DMAMP | 94 | 49 | 62 |
| AMP | 93 | 61 | 55 |
| 3-AB | 94 | 50 | 54 |
| AEPD | 92 | 38 | 55 |
| TEA | 88 | 27 | 33 |

¹data reported is an average over 3 tresses.
²data reported is from a single coil, except for AMPD and AEPD where 2 coils were averaged
³data reported is from an average of 5 coils

In subsequent experiments, it was found that staging the humidity levels in the experiment worked very well and gave a more reliable curl loss. Thus, a more preferred test protocol for the coated wool coils uses an initial 2 hour exposure at 70% relative humidity, followed by 2 hours at 80% relative humidity and finally 2-4 hours and 90% relative humidity. Thus, in addition to the extent of curl loss at 90% relative humidity, this procedure also gives insight as to the onset of curl loss. Data is reported in Table 3.

TABLE 3
Compilation of % curl retention for coated Wool Coils

| | 2 hrs/70% | 2 hrs/80% | | Single 90% RH |
|---|---|---|---|---|
| Aminoalcohol | RH | RH | 2 hrs/90% RH | Treatment/6 hrs |
| None (control) | 98.6 | 96.5 | 92.3 | 94.8 |
| AMP | 94.0 | 79.3 | 55.1 | 61.1 |
| AMPD | 95.2 | 77.2 | 59.3 | 51.1* |
| AEPD | 94.0 | 78.5 | 55.3 | 37.5* |
| TA | 91.3 | 85.8 | 70.6 | 69.1 |
| DMAMP | 90.8 | 81.5 | 62.2 | 49.4 |
| 3-AB | 91.9 | 79.0 | 54.5 | 49.7 |
| TEA | 69.2 | 54.3 | 33.0 | 27 |

*Data an average of 2 runs

As seen in table 2, although the % curl retained is substantially but uniformly lower using the wool coils, the relative ranking of the various aminoalcohols remains essentially unchanged across the 3 tests. Additionally with the wool coils the data is considerably more spread out, giving a level of granularity not available when using human tresses. The un-neutralized polymer (blank control) is minimally affected by humidity. TrisAmino (TA) coatings consistently performed best by a substantial margin in the HHCR tests. Performing below TA but similar to each other was a group of aminoalcohols including AMPD, DMAMP, AMP, and 3-AB. AEPD appeared to be at the low end of this group. TEA was clearly the worst performer. This correlation among the three procedures gives confidence that adopting a wool coil based procedure for screening purposes will provide reliable data that can be expected to translate to human hair tests.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

1. A method of evaluating a material that is useful as at least a portion of a hair fixative composition, comprising the steps of:
providing a composite coil comprising a coil substrate and a fixative coating provided on at least a portion of the coil substrate, wherein:
the substrate coil comprises a plurality of turns and at least a portion of the turns are spaced apart; and
the fixative coating is derived from one or more ingredients including at least the material; and
evaluating a sag resistance characteristic of the composite coil.

2. The method of claim 1, wherein the coil substrate comprises a fiber that has low stretch.

3. The method of claim 1, wherein the coil substrate comprises non-human animal hair.

4. The method of claim 1, wherein the coil substrate comprises wool.

5. The method of claim 1, wherein the coil substrate is substantially free of human hair.

6. The method of claim 1, wherein the coil substrate comprises a uniform spacing pattern among the spaced apart turns.

7. The method of claim 1, wherein the coil substrate comprises a non-uniform spacing pattern among the spaced apart turns.

8. The method of claim 1, wherein the one or more ingredients comprise an amino alcohol.

9. The method of claim 1, wherein the one or more ingredients comprise a poly(meth)acrylate resin.

10. A method of evaluating a material that is useful as at least a portion of a hair fixative composition, comprising the steps of:
providing a supply of a substrate;
using a mechanized force to cause transport of the substrate;
causing the mechanistically transported substrate to be wetted by a fluid precursor of a curable fixative composition;
guiding the wetted, mechanistically transported substrate onto a rotating mandrel in a manner such that the substrate forms a coil comprising spaced apart turns on the mandrel;
curing the wetted fluid precursor in a manner such that a composite coil comprising a cured fixative composition coated onto at least a portion of the coiled substrate is formed; and
causing a sag resistance characteristic of the composite coil to be evaluated.

11. The method of claim 11, wherein the mandrel has a free end.

12. The method of claim 10, wherein the guiding step comprises mechanically driving a guide along at least a portion of the length of the mandrel to help guide the wetted substrate onto the mandrel, said guide being operatively coupled to the mandrel so that the rotation of the mandrel and the driving of the guide are coordinated.

13. The method of claim 12, wherein the wetting step occurs at least partially at a wetting station, and wherein the method further comprises the step of using a translatable guide to help guide the substrate into the wetting station.

14. The method of claim 1, wherein
the coil substrate comprises a non-human fiber.

15. The apparatus of claim 17, comprising:
a mechanically driven, rotatably supported mandrel on which the wetted fiber is drawn from the supply and wound on the mandrel during rotation of the mandrel in a manner effective to form a composite coil precursor comprising a plurality of spaced apart turns; and
a mechanically driven, translatable guide that helps to guide the transported fiber onto the mandrel during translation of the guide, wherein translation of the guide is coordinated with the rotation of the mandrel during at least a portion of the time that the wetted fiber is wound on the rotating mandrel, said coordination occurring in a manner effective to help provide a desired spacing pattern among the spaced apart turns of the coil.

16. The apparatus of claim 17 comprising:
a rotatably supported, mechanically driven mandrel on which the tensioned, wetted fiber is wound to provide a composite coil precursor, said composite coil precursor comprising a plurality of spaced apart turns, and wherein the mandrel is operatively coupled to a driving force in a manner effective to cause mechanically driven rotation of the mandrel on demand.

17. An apparatus for making a composite precursor, comprising:
a supply comprising a fiber that is a surrogate for a human hair fiber;
a wetting station at which the fiber is wetted with a fluid precursor constituting at least a portion of a cured fixative composition; and
a mechanically driven, rotatably supported mandrel.
